(19) United States
(12) Patent Application Publication
(10) Pub. No.: US 2026/0068796 A1
(43) Pub. Date: Mar. 12, 2026

(54) LAWNCARE APPARATUS, METHOD, AND SYSTEM

(71) Applicant: Matthew Leavitt Morris, SR., Haverhill, MA (US)

(72) Inventor: Matthew Leavitt Morris, SR., Haverhill, MA (US)

(21) Appl. No.: 19/325,573

(22) Filed: Sep. 11, 2025

Related U.S. Application Data
(60) Provisional application No. 63/693,221, filed on Sep. 11, 2024.

(51) Int. Cl. A01B 45/02; A01B 49/06

(52) U.S. Cl. CPC A01B 45/026; A01B 49/06

(57) ABSTRACT

The present invention is a lawn maintenance machine capable of aerating, slicing, spiking, and depositing seeds all within a single pass. The present invention is an adaptor system for adapting a pre-existing system so as to enable the current devices to be capable of aerating, slicing, spiking, and depositing seeds all within a single pass. Another aspect of the current invention is a method for adapting a currently existing system so as to be capable of aerating, slicing, spiking and depositing seeds all within a single pass. Another aspect of the present invention is a riding aerator with slicer, spiker, seeder, and spreader.

### CROSS-REFERENCE TO RELATED APPLICATIONS

The instant application is a continuation of U.S. Design Patent Application being filed on Sep. 11, 2025 concurrently with the present application, entitled LAWNCARE SPIKING DISK PLATE (serial number not yet assigned), and a continuation of U.S. Patent Application Ser. No. 63/693221 filed Sep. 11, 2024 entitled LAWNCARE APPARATUS, METHOD, AND SYSTEM, the contents of which are both hereby incorporated by reference in their entirety.

### BACKGROUND OF THE INVENTION

### 1. Field of the Invention

The present invention relates generally to large scale lawn maintenance care systems. Particularly, the present invention relates to aerators and seeders.

### 2. Description of the Prior Art

Aeration is a required aspect of proper turf management. During the aeration process, tines will penetrate the soil profile to allow for air, water, and nutrients to reach the roots of the plant. Regardless of soil and turf type, aeration is necessary and leads to healthy fields, golf courses, and lawns.

U.S. Pat. No. 12,052,938 , by Cook to Stinger Equipment Inc, discloses a riding hydraulically driven aerator. The aerator includes a frame, an engine, one or more hydraulic pumps, one or more drive wheels, one or more tine assemblies, and one or more hydraulic motors. The hydraulic motors are coupled to the drive wheels and to the tine assemblies. The hydraulic pumps provide power to the hydraulic motors and are coupled to the engine with a toothed timing belt.

### SUMMARY OF THE INVENTION

### Advantages and Differences of Invention Over Known Prior Art

One of the most crucial issues faced in turf grass management is the issue of reduced pest control and disease management chemicals. Turf managers must find alternative ways to keep the grass healthy and robust to avoid losing it, thus making mechanical control more suitable for the future of turf grass management.

Aeration enhances the natural soil processes and makes growing resilient and healthy turf easier to cultivate. Different types of aeration have been used in the past to different effect.

The types of aeration systems used in the aeration process are different for each application. As the seasons change and turf needs change, instead of requiring different machines, the present invention seeks to provide a system capable of providing a machine with aeration assemblies that are all-in-one, as well as adjustable and modifiable to work for the goal of the aeration process. Two main different types of aeration that will be discussed according to the present invention include the use of tines and blades.

Hollow tines remove plugs of soil from the turf. These plugs can be quite large, and they need to be removed or brushed to allow for better oxygenation of the soil. Hollow tines do a great deal of benefit in turf that is struggling with thatch and soil compaction issues.

In addition to tine depth and diameter, the type of tine used will also play into the type of aeration and its overall impact. The two main types of tines are the solid and the hollow tines. Solid tines are generally used for less invasive aeration procedures. A solid tine lifts the soil and breaks up compaction, creating space to improve air pockets within the soil profile. The solid tine does not remove soil cores and typically heals quite a bit faster as a result.

Hollow tine aeration is especially beneficial in relieving issues with soil compaction. The removal of the plugs from a hollow tine aeration makes room for air, water, oxygen, and nutrients to make their way into the soil. A significant part of the aeration process is to ensure that soil compaction is not occurring below a shallow tine aeration. Most facilities will vary the depth of their aeration process to ensure that the natural compaction pans are reduced.

A deep tine aeration can encourage deeper root growth. With growth encouraged deeper in the soil, the overall health of the turf improves. Deeper root systems make the grass more resilient and better able to handle issues like temperature changes and periods of drought or extreme rain.

Thatch buildup makes it difficult for turf to get the necessary nutrients to remain healthy. The hollow tine aeration and sometimes solid tine aeration will manage thatch buildup and create a healthier environment for turf to thrive.

With tines penetrating the soil's surface, it is easier for water and fertilizer to access the plant's roots. The tine type and depth provided ensure proper fertilization and improved overall drainage.

Slice aerators work by cutting a series of very thin, yet deep holes into the ground to allow oxygen to penetrate. A slicing aerator uses rotating blades to cut into the ground, creating pathways for air, water, and nutrients in the soil. This process is similar to spiking, but the slicing action can also slice through roots.

Slice seeding creates at least 1-inch-deep slits in the ground with vertical blades and deposits seed directly into the slits created in the soil using equipment called a slice seeder or slit seeder.

As discussed above, with tines, soil plugs are pulled out of the ground which relieve compaction while creating space for great seed to soil contact when the lawn is overseeded. Alone, after thousands of soil plugs are pulled, it is then necessary to go back over the ground and overseed over all of the holes created.

Slice seeding is more aggressive than core aeration & seeding and gives a little bit more of an immediate result. Instead of grass growing out of the tiny holes created, the grass will grow in rows (similar to corn field rows) and result in that desired ‘carpet’ effect quicker than with core aeration and separate seeding.

With slice seeding, grass seed is dropped directly into the furrows created, putting seed directly in contact with soil. Slice seeders ensure that the channels in the soil are formed at just the right depth. It's not the same as broadcasting seed over a lawn. Instead, the seed is laid directly into the furrows/slits created in the soil by the slice seeder equipment.

Traditionally though, slice seeding takes 6× as much labor overall. The present invention combines the capabilities of the traditional machines into a single machine acting with the effectiveness of a slicer, aerator, and seeder all-in-one. This ensures that the benefits of each machine are provided in a single device without sacrificing effectiveness or efficiency.

The prior art was unsatisfactory because clients had to choose between one or another feature. By combining each feature along with a new blade system, the present combination machine enables lawn maintenance to be provided at a higher efficiency without sacrificing effectiveness. It is an object of the present invention to address the deficiencies of the prior art mentioned here.

It is another object of the present invention to provide a lawn maintenance machine capable of aerating, slicing, and depositing seeds all within a single pass. It is a further object of the present invention to provide an adaptor system, for adapting a pre-existing system so as to enable the current devices to be capable of aerating, slicing, and depositing seeds all within a single pass. It is yet another object of the invention to provide a method for adapting a currently existing system so as to be capable of aerating, slicing, and depositing seeds all within a single pass.

The present invention achieves these and other objectives by providing a riding aerator with slicer, seeder, and spreader.

The present invention achieves these and other objectives by providing a combined turf modulator capable of turf preparation on a ground having a motor capable of rotating an axle; an aerator assembly affixed to the rotating axle capable of aerating the turf, the aerator assembly having at least one removable system, capable of creating vertical channels in the turf, and having at least one fixed system capable of creating vertical hollow cylindrical holes in the turf; a seeder capable of releasing seeds; and a removable combined spreader and distributor capable of evenly distributing the released seeds and spreading the distributed seeds into the vertical channels and vertical hollow cylindrical holes in the ground.

The at least one fixed system of the aerator assembly may have a tine system affixed to the rotating axle capable of removing plugs from the turf and creating the vertical hollow cylindrical holes in the turf.

The at least one removable system of the aerator assembly may have a removable slicer capable of slicing the turf and creating the vertical channels in the turf.

The at least one removable system of the aerator assembly may have a removable spiker capable of spiking the turf and creating the vertical channels in the turf.

The at least one removable system of the aerator assembly may have sets of removable connectors capable engaging connector holes on removable half-discs, each half-disc having a solid plate with a interior central hub which abuts and matingly engages the axle, and each half-disc having an exterior edge which engages the turf when the turf modulator is operating.

The interior central hub of each half-disc may have a thickness at least four times greater than a thickness of the exterior edge.

The interior central hub of each half-disc may have a thickness at least two times greater than a thickness of the exterior edge.

The thickness of the interior central hub of each half-disc may be equal to a thickness of the exterior edge of each half-disc.

The exterior edge of each half-disc may have a set of spikes.

The exterior edge of each half-disc may have a sharpened edge.

The present invention achieves these and other objectives by providing a removable aerator assembly for a plug remover capable of turf preparation on a ground, the plug remover having a motor capable of rotating an axle and creating vertical hollow cylindrical holes in the turf, and a seeder capable of releasing seeds; the removable aerator assembly may have at least one of: a first removable aerator system capable of creating vertical channels in the turf and cutting the turf; and a second removable aerator system capable of creating vertical channels in the turf and spiking the turf; wherein each of the first and second removable aerator systems may have a plurality of sets of removable connectors, and a plurality of sets of removable half-discs, respectively; the plurality of sets of removable connectors capable engaging a plurality of connector holes on the plurality of sets of removable half-discs thereby affixing the plurality of removable half-discs along the axle; each of the plurality of sets of removable half-discs having two half-discs; each of the two half-discs having a solid plate with a interior central hub which abuts and matingly engages the axle, and each of the two half-discs having an exterior edge which engages the turf when assembled and operating.

The removable aerator assembly may have both of the first removable aerator system capable of creating vertical channels in the turf and cutting the turf; and second removable aerator system capable of creating vertical channels in the turf and spiking the turf.

The interior central hub of each half-disc may have a thickness at least four times greater than a thickness of the exterior edge.

The interior central hub of each half-disc may have a thickness at least two times greater than a thickness of the exterior edge.

A thickness of the interior central hub of each half-disc being equal to a thickness of the exterior edge of each half-disc.

The exterior edge of each half-disc may have a first set of spikes, a second set of spikes, and a third set of spikes.

Each of the first set of spikes, second set of spikes, and third set of spikes, may have a trailing portion, a leading portion, and an inlet portion between the leading and trailing portion, respectively.

Each of the trailing portion, the leading portion, and the inlet portion may have an arcuate distance, respectively.

Each trailing portion arcuate distance may be greater than each leading portion arcuate distance, and each leading portion arcuate distance may be greater than each inlet arcuate distance, respectively.

The exterior edge of each half-disc may be a sharpened edge.

### BRIEF DESCRIPTION OF THE DRAWINGS

FIG. 1 is a top view of a lawn turf after implementation of the combined turf modulator according to one embodiment of the present invention.

FIG. 2 is a top perspective view of the combined turf modulator according to one embodiment of the present invention.

FIG. 3 the combined turf modulator according to one embodiment of the present invention, with cover pulled away to show each of the major systems.

FIG. 4 is a top rear perspective view of the distribution system of the embodiment according to FIG. 2 attached to the plug collection tray.

FIG. 5 is a rear view of the aerator assembly according to one embodiment of the present invention.

FIG. 6 is a top view of one set of the half-discs according to one embodiment of the present invention shown pre-assembly.

FIG. 7 is a top view of one of the half-discs according to one embodiment of the present invention shown pre-assembly.

### DETAILED DESCRIPTION OF THE INVENTION

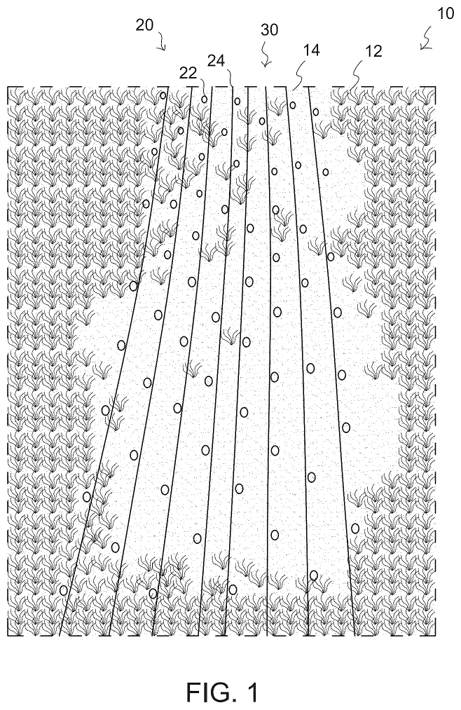

The present invention is now described with reference to illustrations in FIGS. 1-7.

### FIG. 1: Turf Preparation

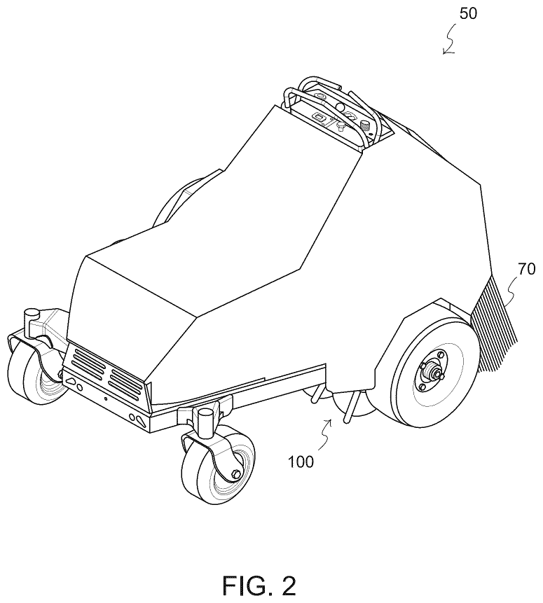

FIG. 1 illustrates a representation of a real-life turf after application with the present inventive system 50. Specifically, after implementation of the embodiment shown in FIGS. 2-6 without the spreader which showed that the present inventive process on bare soil clearly results in both core aeration holes, disc channels, and well seeded soil.

As shown, this turf 10 is an example of a plot of land having spots of more healthy turf 12 and spots which are compressed 14. The present system 50 provides aeration 20 through both channels 24 and core holes 22 as well as evenly distributed fertilizer and seeds 30. This dual aeration 20 enhances the natural soil 10 processes and makes growing resilient and healthy turf 12 easier.

Tines 80 penetrate the surface of the compressed soil 14, making it easier for water and fertilizer to access the plant's roots, providing proper fertilization and improving overall drainage. The blades 102 of the system 50 work by pressing a series of very thin, yet deep channels 24 into the ground to allow oxygen to penetrate. Coring pulls thin cores of dirt from the ground, allowing the ground to breathe. While the blades 102 rotate to press into the ground, creating pathways for air, water, and nutrients in the soil. Blades 102 may either have an exterior edge 115 that is sharpened or spiked. Regardless, these blades 102 create deep slits in the ground with vertical blades, and the seeder can then deposit seed 30 directly into the channels 24.

With prior art aerators, soil plugs are pulled out of the ground which relieve compaction while creating space for great seed to soil contact when the lawn is overseeded. After thousands of soil plugs are pulled, it is then necessary to go back over the ground and overseed over all of the plug holes 24 created with a second device. With the present invention, the spreader ensures the seeds 30 are evenly distributed and fills in the edges of the soil core holes 24.

Slice seeding gives a little bit more of an immediate result. Instead of grass growing out of the tiny holes created, the grass will grow in rows and results in that desired ‘carpet’ effect quicker than with core aeration and seeding alone. With the combined system 50, the benefits of both core aeration and slice seeding are realized, as grass seed is dropped directly into the furrows 24 created, putting seed directly into the furrows/slits 24 created in the soil by the combined system 50.

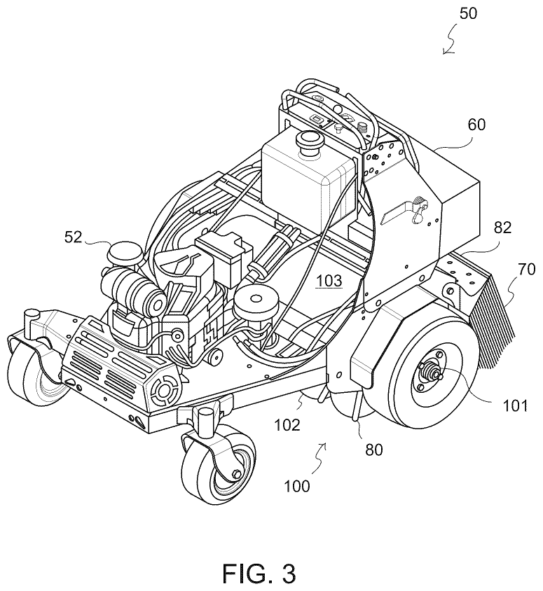

### FIGS. 2-3: Combined Turf Modulator

Shown in FIGS. 2 and 3 is a combined turf modulator 50 according to the present invention having an aerator assembly, seeder, and spreader. This device started as a modified 30″ riding aerator having an aerating forward speed of up to 7 mph and a reverse speed of up to 3 mph. This had an engine 52 which is preferably a Kawasaki FS651 with a 6 gallon fuel capacity and weight of 960 lbs. A width of 48″ and length of 67.5″. With the platform up, length is reduced at only 58.5. A height of 47″. An aerating width of 30″ and an aerating depth of up to 4″, with drive tires of 18×7.50−10.

Previously there were two types of aeration devices. The first were machines that plug holes in a yard. It was not the most efficient preparatory process because traditionally, it required placing the seeds in separately in order to be effective. Another machine “sliced” your yard, such that the effectiveness of seeding is higher—but with these devices the labor is 6× higher, so it is much more inefficient and costly. The present invention addresses the problems of the prior art by reducing the labor involved by providing a machine capable of doing all the required lawn maintenance in a single pass—improving efficiency without sacrificing effectiveness.

The present invention was originally created by modifying a machine that originally had only plugs. As modified, the combined turf modulator 50 now has an aerator assembly 100, seeder 60, and spreader 70. The aerator assembly 100 has tines 80 and blades 102 affixed around the main axle 101. A seed feeding box 60 is attached to the back of the machine 50 and releases the seeds 30. Then, behind the blades 102, a distributor ensures even distribution of the seeds 30 into the channels 24 made by the blades 102. The seeds are gently pushed into the ground by the spreader 70.

The aerator assembly 100 position switch allows for 2 different operating styles and the ability to lock the aerator assembly 100 in the up position for transport. In the up position, the aerator assembly 100 will remain up unless the foot pedal is depressed. In a transport mode, the foot switch is deactivated and the aerator assembly 100 will remain up. In the down position, the aerator assembly 100 will remain in the ground until the foot pedal is depressed. Having the aerator assembly 100 default in the up position is most common. Using the default down position can be advantageous for users that typically do larger properties. Aerator assembly 100 depth is determined by the amount of down pressure.

For deeper core holes 24 and channels 22, turn the pressure up using the regulators. Lower pressures will facilitate shallower deeper core holes 24 and channels 22. Aerator assembly 100 pressure may be adjusted according to soil conditions.

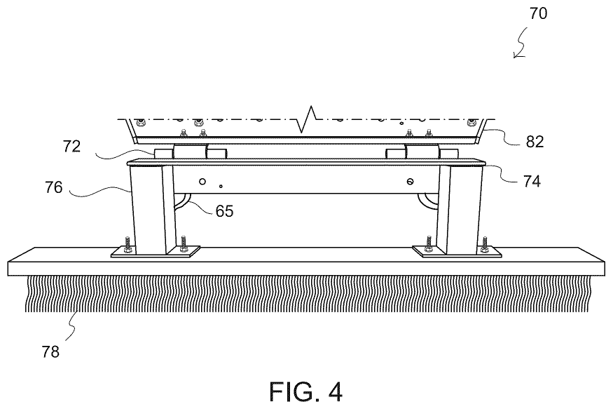

### FIG. 4: Seed Distributor/Spreader

FIG. 4 is a top rear perspective view of the dispersal system of the embodiment according to FIG. 2 attached to the plug collection tray. The seeder is not shown. The distribution attachment ensures that seeds are distributed to fall into the holes made by the tines. The slices allow depth. The spreader attachment 70 ensures that the seeds 30 are spread evenly so that they fall into the holes and channels instead of remaining on the surface of the soil. A rotating hinge 72 connects the main frame 74 of the spreader 70 to a rear portion of the turf modulator 50. In a combined distributor/spreader, shafts 76 may be hollow to release seeds more evenly along the distributor 70. Stiff parallel fibers 78 extrude downward from frame 74 so that the seeds are gently yet firmly spread evenly after being released. These fibers 78 also gently tuck in the edges of the holes created by the plug tines 70.

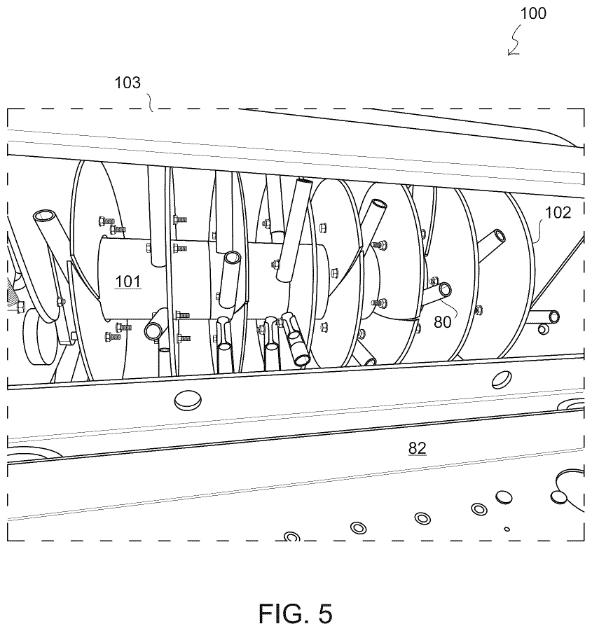

### FIG. 5: Aerator Systems

FIG. 5 is a perspective view of one embodiment of aerator assembly 100 of the turf modulator 50 according to the present invention. In this embodiment, core aerator tines 80 are bolted to solid steel studs welded directly to the drum on the main axle 101. The tines 80 have a shaft that is connected to the drum. In this embodiment, bolts are drilled through the tines and connecting shafts. These tines 80 are hollow with open faces on two ends, and a further open side along one wall to allow the plug to exit.

In this embodiment, ten disc sets of two blades 102 each, are also affixed around the main axle 101 to the drum. Each set of slit seed discs 102 are assembled by predrilled holes 108 in each half disc 102 lining up with 3 core aerator tine bolt holes of the present invention. Plugs removed from the lawn by the spoon studs are collected in the plug shelf 82. The slit discs are removably affixed to the tines by bolts and thus enables the user to switch blade types between different applications. Currently unused disc sets may be stored in a disc box near the seed box.

Each set of half discs 102 are affixed around the main axle 101 of the drum so that a slit 104 is formed between leading and trailing edges of the discs 102. When the seeds are released evenly above the aerator assembly, these slits guide the seeds into the channels formed in the ground. Then the spreader follows and tucks them in more thoroughly. In most embodiments, the half-discs are attached to the axle by attachment to the tines, so they extend perpendicularly from the axle. In other embodiments, the half-discs are attached to the axle by attachment directly to the axle. In these embodiments, the half-discs may extend at a non-perpendicular angle from the axle.

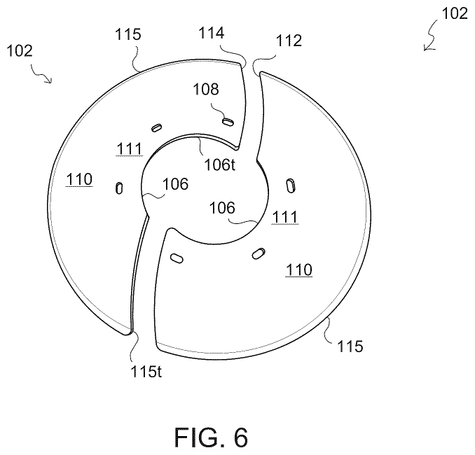

### FIG. 6: Sharpened Blades

FIG. 6 is a top view of one slit disc (two blades 102) of the present invention pre-assembly. In this embodiment, the central hub 106 allows each set of two blades 102 to be fittingly affixed around the main axle 101 to the drum. The discs have attachment holes 108 which allow bolts to be releasably affixed to hold the slit disc in place. The attachment holes are aligned along an interior portion 111 of the main plate of the half disc 102. A leading edge 114 and trailing edge 112 of the half disc 102 have convex and concave shapes that correspond to one another. The thickness 106t of the central hub 106 of the disc is generally at least twice the thickness 115t of an exterior edge 115 of the half disc 102. The thickness 106t of the central hub 106 of the sharpened disc may be at least four times the thickness 115t of an exterior edge 115 of the half disc 102.

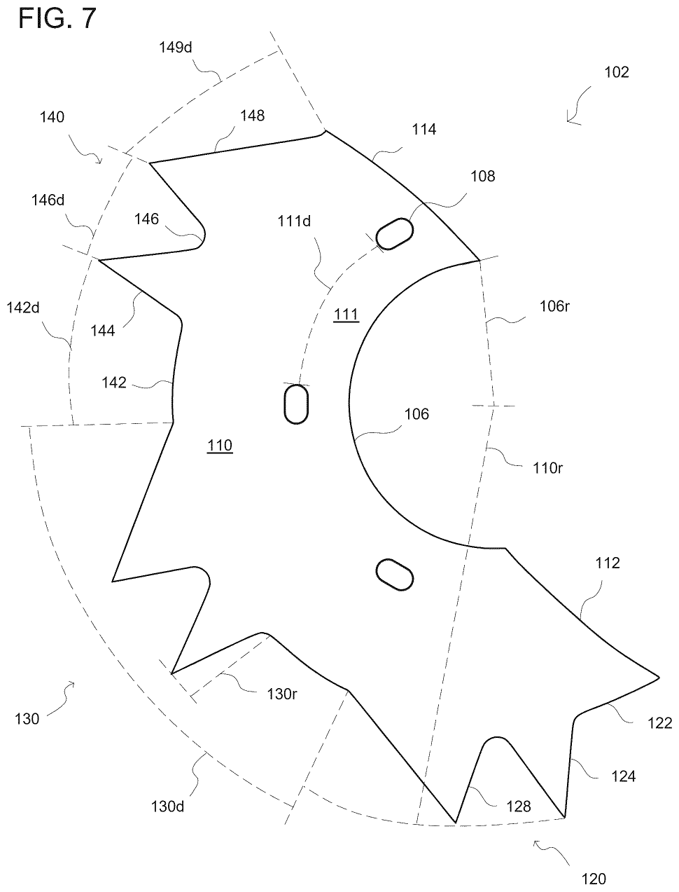

### FIG. 7: Spiked Blades

FIG. 6 is a top view of a half disc blade 102 of the present invention pre-assembly. In this embodiment, the central hub 106 again allows each set of two blades 102 to be fittingly affixed around the main axle 101 to the drum. The half discs 102 have attachment holes 108 which allow bolts to be releasably affixed to hold the slit discs 102 in place. The attachment holes 108 are aligned along an interior portion 111 of the main plate of the half disc 102. A leading edge 114 and trailing edge 112 of the half disc 102 have convex and concave shapes that correspond to one another.

The thickness 106t of the central hub 106 of the disc more or less at least twice the thickness 115t of an exterior edge 115 of the half disc 102. Spiked blades 102 of a disc set may have a first set of spikes 120, a second set of spikes 130, and a third set of spikes 140 which are placed equidistant along the perimeter of the exterior edge 115 of the main solid plate 110. Each set of spikes 120, 130, 120 has a leading portion 122, 132, 142, a first spike 124, 134, 144, an inlet 126, 136, 146, and a second spike 128, 138, 148 with a trailing edge 129, 139, 149.

For the following discussion in reference to FIG. 7, it is noted that in order to reduce clutter and improve overall clarity, reference numbers to equivalent elements or equivalent distances on FIG. 7 are not duplicated. Arcuate distances of an element are referred to by following the reference number of the element with the letter “d”. Radial distances of an element are referred to by following the reference number of the element with the letter “r”.

In this embodiment, each set of spikes 120, 130, 120 has comparable elements and measurements.

Each set of spikes 120, 130, 120 has an entire arcuate distance 120d, 130d, 140d that is equidistant with one another. The entire arcuate distance 120d, 130d, 140d for each set of spikes 120, 130, 120 is equal to one third of the entire arcuate distance 115d of the exterior edge 115 of the main plate 110. For the first set of spikes 120, the entire arcuate distance 120d is measured from the edge 112 to the trailing base of the second spike 128. For the second and third set of spikes 130, 140, the entire arcuate distance 130d, 140d is measured from the respective trailing base of each proceeding second spike 128, 138 to the trailing base of each respective second spike 138, 148.

Each leading portion 122, 132, 142 of each set of spikes 120, 130, 120 has an arcuate distance 122d, 132d, 142d. Each leading portion 122, 132, 142 of each set of spikes 120, 130, 120 has an arcuate distance 122d, 132d, 142d that is equivalent and equidistant. For the first set of spikes 120, the leading portion is measured from the edge 112 to the peak of the first spike 124. For the second and third set of spikes 130, 140, the leading portion is measured from the base of each second spike 138, 148 to the peak of each first spike 134, 144, respectively.

Each first spike 124, 134, 144 of each set of spikes 120, 130, 120 has an arcuate distance 124d, 134d, 144d that is equivalent. However, the arcuate distances 124d, 134d, 144d are generally not measured separately. Half this arcuate distance 124d, 134d, 144d is included in the arcuate distance 122d, 132d, 142d of the leading portion 122, 132, 142. The other half of this arcuate distance 124d, 134d, 144d is included in the arcuate distance 126d, 136d, 146d of the inlet 126, 136, 146.

Each inlet 126, 136, 146, of each set of spikes 120, 130, 120 has an arcuate distance 126d, 136d, 146d, that is equivalent to one another. The inlet arcuate distance 126d, 136d, 146d, is measured from the peak of each first spike 124, 134, 144 to the peak of each second spike 128, 138, 148.

Each trailing portion 129, 139, 149 of each second spike 128, 138, 148 has an arcuate distance 129d, 139d, 149d, that is equivalent to one another. The arcuate distance 129d, 139d for the first and second set of spikes 120, 130 is measured from the peak of each second spike 128, 138 to the leading portion 132, 142 of each following set of spikes 130, 140, respectively. For the third set of spikes 140, the trailing edge 149 is measured from the peak of the second spike 148 to the trailing edge 114 of the disc plate 110.

Each trailing portion arcuate distance 129d, 139d, 149d is greater than each leading portion arcuate distance 122d, 132d, 142d. Each leading portion arcuate distance 122d, 132d, 142d is greater than each inlet arcuate distance 126d, 136d, 146d.

In a further embodiment, the discs 102 have a bracket along each side of the slit so that the discs may be affixed to one another without drilling into the tines. Mirror images of one another, a first connector connects with a second connector ensuring secure fixation. Securely fixed to one another around the shaft of the drum ensures that the blades are not accidently removable once affixed. Two jutting portions axially interact with the tines so that the blades rotate with the drum.

### LIST OF REFERENCED ELEMENTS

The following reference numbers are adhered to within the specification to refer to those referenced elements within the drawings of the present application.
lawn 10
healthy grass 12
bald spots 14
aeration 20
core hole 22
slits 24
seeding 30
turf modulator 50
engine 52
seeder box 60
tubes 65
seed spreader 70
rotating hinge 72
frame 74
shafts 76
parallel fibers 78
tine 80
plug tray 82
aerator assembly 100
main axle 101
blades 102
aerator cover 103
slit 104
central hub 106
central hub radius 106r
attachment holes 108
main plate 110
main plate radius 110r
interior plate 111
leading edge 112
trailing edge 114
exterior edge 115
first, second, third set of spikes 120, 130, 140
leading portions 122, 132, 142
first spikes 124, 134, 144
valleys 126, 136, 146
second spikes 128, 138, 148
trailing portion 129, 139, 149
leading portion arcuate distance 122d, 132d, 142d
inlet arcuate distance 126d, 136d, 146d
trailing portion arcuate distance 129d, 139d, 149d

### CONCLUSION

Although the preferred embodiments of the present invention have been described herein, the above description is merely illustrative. Further modification of the invention herein disclosed will occur to those skilled in the respective arts and all such modifications are deemed to be within the scope of the invention as defined by the appended claims.

What is claimed is:

1. A turf modulator capable of turf preparation on a ground comprising:
a motor capable of rotating an axle;
an aerator assembly affixed to the rotating axle capable of aerating the turf, the aerator assembly having at least one removable system, capable of creating vertical channels in the turf, and having at least one fixed system capable of creating vertical hollow cylindrical holes in the turf;
a seeder capable of releasing seeds; and
a removable combined spreader and distributor capable of evenly distributing the released seeds and spreading the distributed seeds into the vertical channels and vertical hollow cylindrical holes in the ground.

2. The turf modulator of claim 1 wherein the at least one fixed system of the aerator assembly further comprising a tine system affixed to the rotating axle capable of removing plugs from the turf and creating the vertical hollow cylindrical holes in the turf.

3. The turf modulator of claim 1 wherein the at least one removable system of the aerator assembly further comprising a removable slicer capable of slicing the turf and creating the vertical channels in the turf.

4. The turf modulator of claim 1 wherein the at least one removable system of the aerator assembly further comprising a removable spiker capable of spiking the turf and creating the vertical channels in the turf.

5. The turf modulator of claim 1 wherein the at least one removable system of the aerator assembly further comprising sets of removable connectors capable engaging connector holes on removable half-discs, each half-disc having a solid plate with a interior central hub which abuts and matingly engages the axle, and each half-disc having an exterior edge which engages the turf when the turf modulator is operating.

6. The turf modulator of claim 5 wherein the interior central hub of each half-disc having a thickness at least four times greater than a thickness of the exterior edge.

7. The turf modulator of claim 5 wherein the interior central hub of each half-disc having a thickness at least two times greater than a thickness of the exterior edge.

8. The turf modulator of claim 5 wherein a thickness of the interior central hub of each half-disc being equal to a thickness of the exterior edge of each half-disc.

9. The turf modulator of claim 5 wherein the exterior edge of each half-disc having a set of spikes.

10. The turf modulator of claim 5 wherein the exterior edge of each half-disc having a sharpened edge.

11. A removable aerator assembly for a plug remover capable of turf preparation on a ground, the plug remover having a motor capable of rotating an axle and creating vertical hollow cylindrical holes in the turf, and a seeder capable of releasing seeds; the removable aerator assembly comprising at least one of:
a first removable aerator system capable of creating vertical channels in the turf and cutting the turf; and
a second removable aerator system capable of creating vertical channels in the turf and spiking the turf;
wherein each of the first and second removable aerator systems comprising a plurality of sets of removable connectors, and a plurality of sets of removable half-discs, respectively;
the plurality of sets of removable connectors capable engaging a plurality of connector holes on the plurality of sets of removable half-discs thereby affixing the plurality of removable half-discs along the axle;
each of the plurality of sets of removable half-discs having two half-discs; each of the two half-discs having a solid plate with a interior central hub which abuts and matingly engages the axle, and each of the two half-discs having an exterior edge which engages the turf when assembled and operating.

12. The removable aerator assembly of claim 11 comprising both of the first removable aerator system capable of creating vertical channels in the turf and cutting the turf; and second removable aerator system capable of creating vertical channels in the turf and spiking the turf.

13. The removable aerator assembly of claim 11 wherein the interior central hub of each half-disc having a thickness at least four times greater than a thickness of the exterior edge.

14. The removable aerator assembly of claim 11 wherein the interior central hub of each half-disc having a thickness at least two times greater than a thickness of the exterior edge.

15. The removable aerator assembly of claim 11 wherein a thickness of the interior central hub of each half-disc being equal to a thickness of the exterior edge of each half-disc.

16. The removable aerator assembly of claim 11 wherein the exterior edge of each half-disc having a first set of spikes, a second set of spikes, and a third set of spikes.

17. The removable aerator assembly of claim 16 wherein each of the first set of spikes, second set of spikes, and third set of spikes, having a trailing portion, a leading portion, and an inlet portion between the leading and trailing portion, respectively.

18. The removable aerator assembly of claim 17 wherein each of the trailing portion, the leading portion, and the inlet portion have an arcuate distance, respectively.

19. The removable aerator assembly of claim 18 wherein each trailing portion arcuate distance is greater than each leading portion arcuate distance, and each leading portion arcuate distance is greater than each inlet arcuate distance, respectively.

20. The removable aerator assembly of claim 11 wherein the exterior edge of each half-disc having a sharpened edge.
